(19) United States
(12) Patent Application Publication
(10) Pub. No.: US 2003/0208417 A1
(43) Pub. Date: Nov. 6, 2003

(54) Inventory management

(76) Inventors: Matthias Heinrichs, Speyer (DE); Pascale Van Laethem, Ketsch (DE); Markus Seng, Berlin (DE); Achim Heger, Berlin (DE)

Correspondence Address: MARK D. KIRKLAND, Fish & Richardson P.C., Suite 500, 500 Arguello Street, Redwood City, CA, 94063, US

(21) Appl. No.: 10/158,179

(22) Filed: May 31, 2002

Related U.S. Application Data
(63) Continuation-in-part of application No. 10/136,847, filed on Apr. 30, 2002.

(51) Int. Cl. G06F 17/60

(52) U.S. Cl. 705/28

(57) ABSTRACT

A method is described for updating information relating to an item of stock in a supply chain that resides in a storage facility of a custodian of the stock when the ownership of the item of stock passes from a first owner to a second owner. The method includes providing a first data structure representing the custodian of the item of stock, providing a second separate data structure representing the owner of the item of stock, and passing the ownership of the item of stock from the first owner to the second owner. Passing the ownership includes changing the name from the first owner to the second owner in a field in the second data structure.

### RELATED APPLICATIONS

This application is a continuation-in-part of, and claims priority from, co-pending U.S. patent application Ser. No. 10/136,847 filed on Apr. 30, 2002, having common inventors Matthias Heinrichs, Pascale Van Laetham, Markus Seng, and Achim Heger, common ownership, and titled Inventory Management, the contents of which are incorporated herein by reference.

### BACKGROUND

This invention relates to inventory management.

A typical supply chain management (SCM) system involves the management of materials, information, and finances as they move in a process from a supplier to manufacturer to wholesaler to retailer to consumer. A SCM system can be viewed as a process that includes a product flow, an information flow, and a finance flow. The product flow includes the movement of goods from a supplier to a customer, as well as any customer returns or service needs. The information flows involves transmitting orders and updating the status of the delivery. The finance flow consists of credit terms, payment schedules, and consignment and title ownership arrangements. All these different types of flows are typically controlled and monitored using some type of computer software.

Typically, SCM software can be divided into two application categories: planning applications and execution applications. Planning applications use advanced algorithms to determine the best means to fill an order. Execution applications track the physical status of goods, the management of materials, and financial information involving the parties.

SAP AG, located in Walldorf, Germany provides SCM solutions for product manufacturers to help them reach their goals. The solutions are based on the mySAP.com e-business platform (see www.sap.com for further information). One of the building blocks of the e-business platform is the SAP R/3 component that provides enterprise resource planning functionality. The SAP R/3 component contains functionality for managing stock quantities for logistical processes, including keeping the stock quantities, recording stock quantity changes resulting from goods movements, and providing information in response to queries about stock quantities and stock movements.

The changing nature of supply chains causes new needs that can not or can only partly be fulfilled by existing solutions, such as the SAP R/3 component. For example, the flow of goods in a global supply chain often includes the participation of several partners working with different SCM systems. It would be desirable to be able to retrieve stock information throughout the whole supply chain, which is currently not possible. Another example of new needs relates to logistic service providers, who need to manage physical inventory from different companies in a single warehouse. In existing applications, the storage structure is typically linked to a company's structure and allows no distinction between an organization that manages the stock (that is, a stock operator or custodian) and a stock owner. There is also an increased need for management of stock quantity data substantially in real time.

### SUMMARY

In one aspect, the invention relates to a method of updating information relating to an item of stock in a supply chain that resides in a storage facility of a custodian of the stock when the ownership of the item of stock passes from a first owner to a second owner. The method includes providing a first data structure representing the custodian of the item of stock, providing a second separate data structure representing the owner of the item of stock, and passing the ownership of the item of stock from the first owner to the second owner. Passing the ownership includes changing the name from the first owner to the second owner in a field in the second data structure.

Implementations of the method may include one or more of the following features. For example, the method may further include inputting the name of the custodian of the item of stock in a single field in the first data structure. The method also may further include inputting the name of the first owner of the item of stock in a single field in the second data structure. Inputting the name of the first owner of the item of stock may include retrieving the name of the first owner from an XML document.

Passing the ownership may include receiving a notification that specifies a change in ownership of the item of stock from the first owner to the second owner. Receiving a notification that specifies a change in ownership may include receiving an XML document.

The method may further include providing a set of subscriber rules from an external application. The method may still further include applying the set of subscriber rules to a notification of a change in ownership of the stock item to create data. The method may still further include dispatching the data to the external application. Providing a set of subscriber rules may include providing a set of subscriber rules of an accounting application and/or a finance application. Providing a set of subscriber rules may further include providing criteria that is relevant to the external application.

In another general aspect, the invention is an article that includes a computer-readable medium that stores executable instructions for causing a computer system to provide a first data structure representing the custodian of the item of stock; provide a second separate data structure representing the owner of the item of stock; and pass the ownership of the item of stock from the first owner to the second owner. Passing the ownership includes changing the name of the owner from the first owner to the second owner in a field in the second data structure.

In another general aspect, the invention is a system that includes one or more external computer systems and an inventory management computer coupled to the external computer systems over a network. The inventory management computer is operable to provide a first data structure representing a custodian of an item of stock, provide a second separate data structure representing an owner of the item of stock, and pass the ownership of the item of stock from the first owner to a second owner. Passing the ownership includes changing the name of the owner from the first owner to a second owner in a field in the second data structure.

In various implementations, the invention may provide one or more of the following advantages. The inventory management system may maintain stock quantity data in a single database that is centralized relative to external systems. As a result, there is only a single copy of the stock quantity, which may reduce the time and the need to synchronize data that would otherwise be spread across multiple databases. An external system, such as a SAP system, can update and access stock quantity data in a fast and accurate manner. The inventory management system can manage different types of stock units and handling units located in different locations for industries such as the oil, retail, automotive, high-tech, pharmaceutical, or other industries. The system supports multiple transaction quantities (MTQ) for tracking stock items in different units, for example, meat products can be represented in pieces (PC), weight such a kilograms (kg), or other quantity units.

The flow of goods in a global supply chain often includes the participation of several trading partners such as a logistics service provider (LSP) working with an external system such as a SAP or non-SAP system. In this multiple-system environment, the inventory management system may enable the retrieval of stock information throughout the supply chain by making the stock quantity data visible wherever the stock units reside, for example, in an external warehouse or on a truck. The inventory management system may be compatible with supply chain inventory visibility (SCIV) applications. Such applications can allow enterprises to monitor and manage events across a supply chain to plan their activities more effectively and preempt problems. The system may be also compatible with vendor-managed inventory (VMI) systems in which a vendor is responsible for the replenishment of the stock of his customers.

The inventory management system organizes the stock quantity data using object-oriented techniques, which allow the physical inventory to be represented in a hierarchical inventory structure. For example, the stock quantity data is organized in a structure that includes stock unit data referenced by handling unit data, in turn the handling unit data references stock location data. Thus, it is possible to move any node in the hierarchical structure such that lower level data elements are moved automatically if higher-level data elements are moved. For example, if a handling unit such as a container is moved, a LSP may not need to know the contents of the container. Other examples include, moving stock quantities across different locations, outsourcing of a warehouse in which all the content of the warehouse changes to the operator of the warehouse, moving a structured article such as a display, bulk transportation in tanks and compartments possibly owned by one or more companies each having separate legal structures.

LSPs often need to manage physical inventory from different companies in the same warehouse. The inventory management system removes the link between the storage location structure and the company structure by providing a separate data structure to represent the stock operator and the stock owner. Thus, a logistics service provider in an external warehouse can manage the same material number for different stock units from different companies in the same location. Moreover, changes in corporate structure, such as in the case of a merger or outsourcing, can be easily performed.

A typical inventory system includes separate systems for logistics and accounting. Accounting deals with periodic information whereas logistics is a continuous process that needs exact stock quantities at all times which is often referred to as “zero-latency.” A process disclosed in the invention provides a stock quantity data structure that includes stock quantity and allows other systems, such as an accounting system, to manage value data associated with the stock in a subsequent process and in batch mode.

The supply chain needs to rely on near-real-time stock quantities. The invention allows physical goods movement to be visible in the inventory systems within a short period of time such as fractions of seconds. On the other hand, most subsequent applications such as finance and accounting can accept a certain delay in their data update. For example, these applications can perform their periodic inventory valuation process every hour, by the end of the day or even on a monthly basis. The inventory management system allows these applications to perform their value updates in an aggregated form in a later step without impairing the update to the stock quantity. Thus, the inventory management system uses techniques that help achieve the goal of “zero-latency” in a SCM system in which the goods or information are moved across a supply chain to provide near real time information and reduce in-transit inventory costs.

The inventory management system is based on a flexible data architecture. For example, it can operate in a standalone manner as a sub-component for applications that manage stock quantities, it can be integrated with SAP R/3 systems, it has clearly defined interfaces so as to cooperate with components such as finance, business information warehouse, classical R/3 materials management inventory management (MM-IM) systems as well as with external systems such as warehouse management (WM) systems.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a simplified block diagram of one implementation of an inventory management system.

FIG. 1B is a simplified block diagram of a second implementation of an inventory management system.

FIG. 1C is a simplified block diagram of a third implementation of an inventory management system.

FIG. 2 is a stock quantity entity relationship diagram for an inventory management system.

FIG. 3 is a block diagram showing the flow of information in an inventory management system and between external applications.

FIG. 4A is a layout of an example of a warehouse having storage locations and handling units.

FIG. 4B is a flow chart of a process of changing the ownership of a stock item in the warehouse of FIG. 4A.

FIG. 5 is an example of the hierarchy and the tables used in an inventory management system.

FIG. 6 is a second example of the hierarchy and the tables used in the inventory management system.

Like reference symbols in the various drawings indicate like elements.

### DETAILED DESCRIPTION

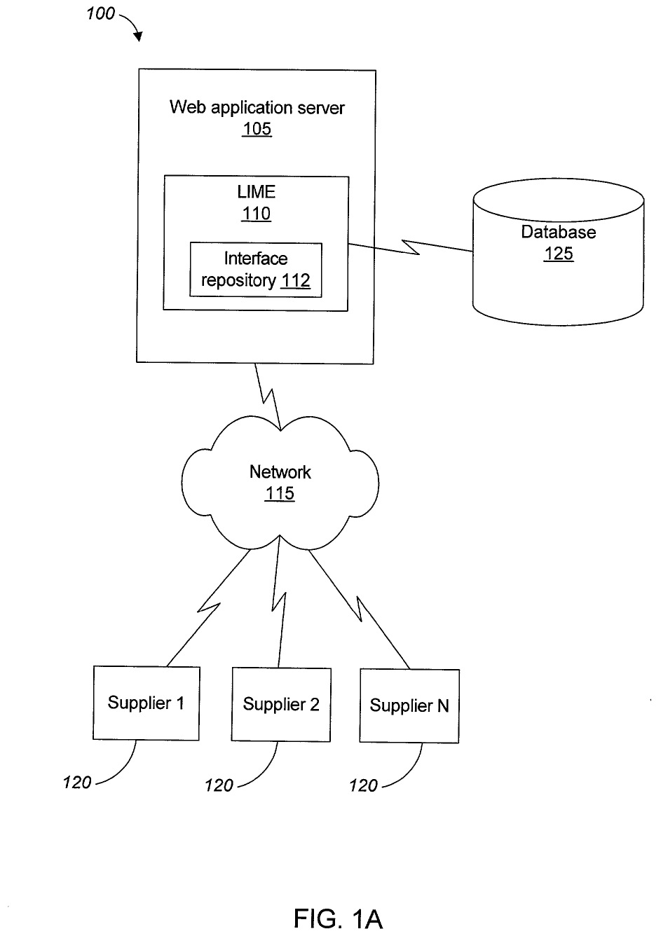

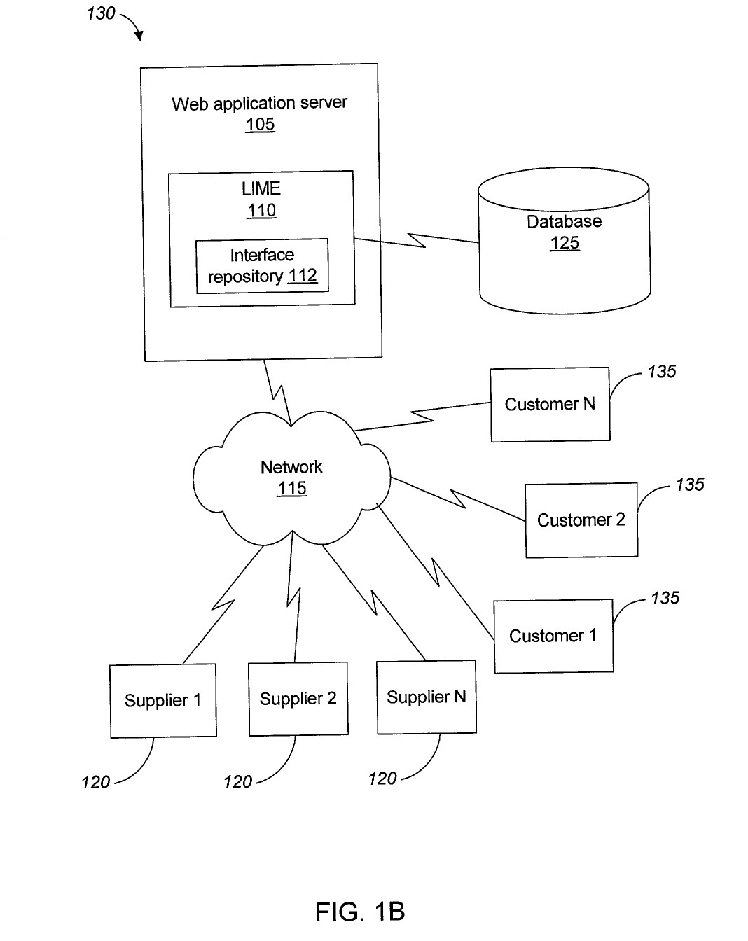

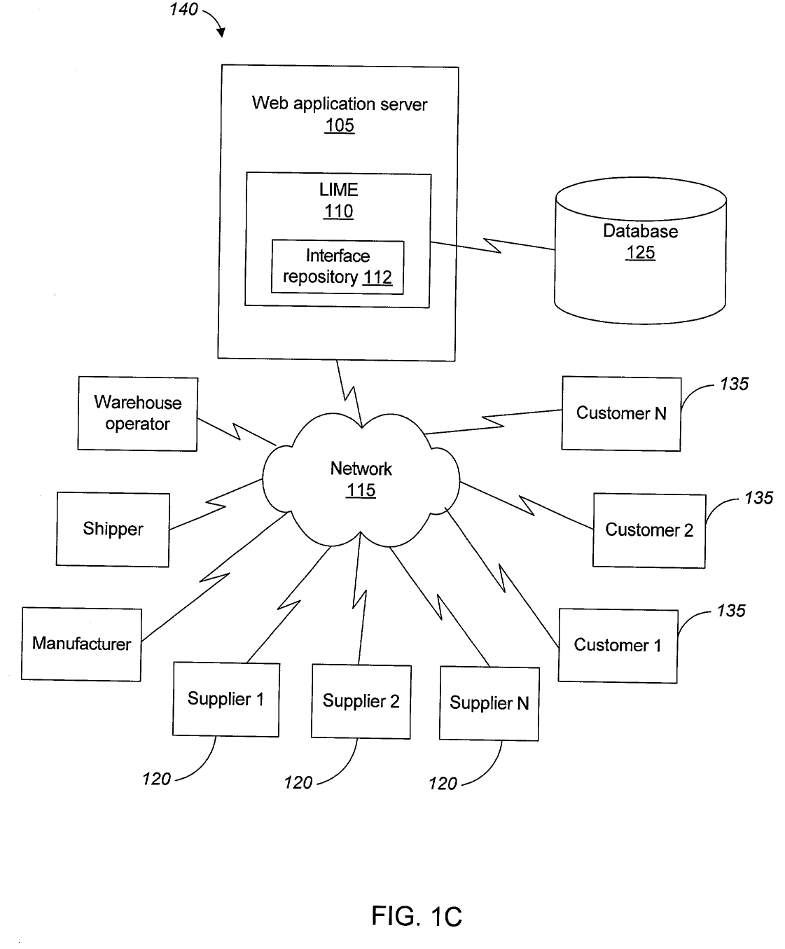

FIG. 1A is a simplified block diagram of one implementation of an inventory management system 100, for example, for a company having one inventory to manage. The company may be a manufacturer that receives supplies from n suppliers and operates the inventory management system 100 in a manner that permits the suppliers to input data regarding the particular stock items they supply to the manufacturer. For example, the manufacturer may have an agreement with the suppliers that all finished product in the suppliers' warehouses that will be available to the manufacturer are to be input into the inventory management system 100 such that the manufacturer will be able to anticipate shortages of supplies. The suppliers also may have authorization to view data in the inventory management system 100 that pertains to levels of the particular stock item they supply. For example, the suppliers may have an arrangement with the manufacturer to maintain an inventory range of a particular part at the manufacturer's facility. Thus, viewing the inventory data will enable the suppliers to supply stock items as necessary to ensure that the number of stock items at the manufacturer's facility is within the specified range. The suppliers also will be able to determine whether they must increase or reduce their production.

The inventory management system 100 includes an inventory management computer 105 that runs an inventory management application 110 and that communicates over a network 115 with the suppliers 120. The inventory management computer 105 communicates with a database 125 that includes inventory related data. The company operating the inventory management computer 105 can be, for example, a manufacturer of simple and/or complex items. A manufacture of a complex item may receive supplies from many suppliers whereas the manufacturer of a simple item may receive supplies from much fewer suppliers. Nevertheless, in either situation the inventory management system operates scalably to handle the transactions required of the system. One example of an inventory management application 110 is SAP's Lean Inventory Management Engine (“LIME”).

An example of a network 115 includes a wired or wireless network such as the Internet. The inventory management computer 105 can be, for example, a Web-based server computer that includes the inventory management application 110 that uses the database 125 to store stock data, queries, and transaction requests received from the suppliers 120. The inventory management application 110 can be used with any external system and includes an interface that provides a set of interface layers between the queries and transaction requests received from the suppliers and the inventory management application 110. For example, although a user will not interface directly with the LIME inventory management application, the LIME application has a set of interface layers that will interface with external systems thereby allowing a user to query the LIME application and create transactions.

FIG. 1B is a simplified block diagram of an implementation of a second inventory management system 130 to, for example, a company that receives stock items from n suppliers 120 and also manufactures and supplies stock items to n customers 135. For example, the customers 135 may be manufacturers of other items. In this implementation, the inventory management system must be able to store the data and handle the queries and transactions of both the suppliers and the customers. The company operating the inventory management computer 105 and inventory management application 110 of FIG. 1B may be, for example, one of the suppliers of FIG. 1A. As may be evident from FIGS. 1A and 1B, each supplier, manufacturer, and customer in a supply chain may have the need to operate an inventory management system 100, 130. Moreover, there may be sharing of some of the data stored in the individual databases 125 between multiple inventory management applications 110 such that the members of the supply chain have as much information as possible to ensure that their inventory management is optimized. The inventory management system 130 can be implemented, for example, by SAP's LIME inventory management system.

FIG. 1C is a simplified block diagram of an implementation of a third inventory management system 140. The inventory management system 140 is operated by a company that functions as a service broker of the inventory management computer 105 and the inventory management application 110 for entities, such as suppliers 120, customers 135, manufacturers 145, warehouse operators 150, and shippers 155. In this implementation, the inventory management system stores the data and handles the queries and transactions of all of the entities that are provided this service by the service broker. Each entity accessing the inventory management application is, for example, provided an authorization code to access only certain data and only the supply chains in which that entity is involved. In this implementation, the entities advantageously avoid the initial capital costs of setting up an inventory management system as well as the ongoing costs of maintaining the software and hardware associated with such a system. However, the entities are required to pay fees to the service broker for the use of the inventory management system 140. The inventory management system 140 can be implemented, for example, by SAP's LIME inventory management system.

An inventory management system, such as those described above, can be implemented as a stand-alone or an integrated database system that relies internally on guids but externally includes hierarchy tables, stock tables, serial number tables, and index tables, all of which are linked together, and all of which are described in more detail below. One example of such an inventory management system is SAP's LIME inventory management system. Although the following description is directed to features of SAP's LIME inventory management system, the principles and methods described herein generally apply to many conventional inventory management systems. The hierarchy tables, stock tables, and serial number tables contain globally unique identifiers (“guids”). The index tables map business keys to the guids. The database uses two types of guids: index guids and node guids. The index guids refer to the index tables for location, handling unit (“HU”), and stock items. The node guids are used to identify a node in the hierarchy of location, handling unit and stock items.

The inventory management system is based on a hierarchy of locations. At a top level is the location, such as a plant or warehouse. At the next lower level is the handling unit, such as a bin, a container, a tank, shelf, etc. At the next lower level is the stock item, such as a can of paint or a box of pens. At the next level, which is the lowest level, is the serial number. Examples of a hierarchy table, a stock table, and a serial number table used in SAP's LIME system, and the types of information used in the tables are as follows. The format and content of these tables are described in more detail below.

Hierarchy table: (/LIME/TREE)

| Mandt | Guid | Guid_Parent | Guid_Node | LVL | Type | Idx | Type_Parent | Idx_Parent |
|---|---|---|---|---|---|---|---|---|
| CLNT 3 | RAW 16 | RAW 16 | RAW 16 | INT 10 | CHAR 1 | NUMC 3 | CHAR 1 | NUMC 3 |

Stock Item table (quantities): (/LIME/STOCK)

| Mandt | Guid | Guid_Parent | VSI | Unit | Quan | Guid_Node |
|---|---|---|---|---|---|---|
| CLNT 3 | RAW 16 | RAW 16 | CHAR 1 | UNIT 3 | QUAN 19,6 | RAW 16 |

Serial Number table: (/LIME/SERIAL)

| Mandt | Guid Node | VSI | Serial No | Guid |
|---|---|---|---|---|
| CLNT 3 | RAW 16 | CHAR 1 | CHAR 40 | RAW 16 |

Examples of a location index table, a handling unit index table, and a stock index table used in, for example, SAP's LIME system and the types of information used in the tables are as follows. The format and content of these index tables are described in more detail below.

Location Index table: (/LIME/LOC_Ixxx)

| | Location | Location | | | |
|---|---|---|---|---|---|
| Mandt | Key 1 | Key n | Guid | Custodian | Logsys |
| CLNT 3 | | | RAW 16 | CHAR 10 | CHAR |
| | | | | | 10 |

Handling Unit Index table: (/LIME/HU_Ixxx)

| | HU | HU | | | |
|---|---|---|---|---|---|
| Mandt | Key 1 | Key n | Guid | Custodian | Logsys |
| CLNT 3 | | | RAW 16 | CHAR 10 | CHAR |
| | | | | | 10 |

Stock Index table: (/LIME/STOCK_Ixxx)

| | Stock | Stock | | Cate- | | |
|---|---|---|---|---|---|---|
| Mandt | Key 1 | Key n | Owner | gory | Guid | Logsys |
| CLNT 3 | | | CHAR 10 | CHAR | RAW 16 | CHAR |
| | | | | 1 | | 10 |

The database model used in SAP's LIME inventory management system allows flexible key definition for locations, handling units and stock items in the index tables. In particular, the stock quantity table /LIME/STOCK, the hierarchy table /LIME/TREE and the serial number table /LIME/SERIAL do not contain any business keys, only guids. However, the index tables contain both guids and business keys such that they map the business keys to the corresponding guids, as illustrated below. As such, the database operates on guids but the user sees tables.

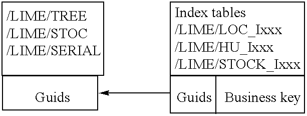

The index tables can be customized by the user of the inventory management system or selected from a set of standard index tables. For example, using a customizing tool, the user can create location index tables and handling index tables that have any or all of the fields listed in the common field location/handling unit index table illustrated below.

| Field | Key | Description |
|---|---|---|
| MANDT | X | Client |
| (Location/HU | X | The business key can contain several fields |
| business key) | | (e.g. WERKS/LGORT) |
| GUID | | Guid of location/HU. Is used in hierarchy |
| | | table /LIME/TREE and as GUID_PARENT in |
| | | table /LIME/STOCK |
| CUSTODIAN | | Custodian of location/HU (e.g. warehouse |
| | | operator) |
| LOGSYS | | Logical system. Is needed if LIME contains data |
| | | from different systems. |

As such, the appearance of location index tables will not necessarily look the same from user to user or even for a user's various location index tables. Similarly, the appearance of handling unit index tables will not necessarily look the same from user to user or even for a user's various handling unit index tables. Also, as noted in the description of the fields, Location/HU business key can contain more than one field, such as a field for the plant and a location within the plant.. The customizing tool allows users to define and create index tables based on their unique needs, such as stock items that do not use standard business keys. For example, if a user has a stock item that is stored or handled in a unique manner, that user can define a location or business key that describes that manner of storage or handling.

Examples of standard location index tables are illustrated below. For example, the location index table LOC_I001 refers to a plant 0001 and storage location 0001 that have been assigned a guid L1. Similarly, the location index table LOC_I002 refers to a warehouse number 001, storage type 001 and a bin location A1-04-02 that have been assigned a guid L1. The location index table LOC_I003 refers to an oil tank 0001 that has been assigned guid L3 and the location index table LOC_I004 refers to a location that has a global location number and has been assigned guid L4.

LOC_I001

| | WERKS | LGORT | GUID |
|---|---|---|---|
| Plant, storage location | 0001 | 0001 | L1 |

LOC_I002

| | LGNUM | LGTYP | LGPLA | GUID |
|---|---|---|---|---|
| WM bin location | 001 | 001 | A1-04-02 | L2 |

LOC_I003

| | TANK | GUID |
|---|---|---|
| Oil tank | 0001 | L3 |

LOC_I004

| | GLN | GUID |
|---|---|---|
| Global Location Number | 1234512345123 | L4 |

Examples of standard handling unit index tables are illustrated below. For example, the handling unit index table HU_I001 refers to a R/3 handling unit having an identifier EXIDV and that has been assigned a guid H1. The handling unit index table HU_I002 refers to a shipping container handling unit having a serial shipping container code and that has been assigned a guid H2.

HU_I001

| | EXIDV | GUID |
|---|---|---|
| R/3 handling unit | 12345123451234512345 | H1 |

HU_I002

| | SSCC | GUID |
|---|---|---|
| Serial shipping container | 10614141192837465 | H2 |
| code | | |

Like the location index tables and the handling unit index tables, the stock index tables can be customized by the user of the inventory management system or selected from a set of standard stock index tables. For example, using a customizing tool, the user can create stock index tables that have any or all of the fields listed in the common field stock index table illustrated below. As such, the appearance of stock index tables will not necessarily look the same from user to user or even for a user's various stock index tables. Also, as noted in the description of the fields, the stock business key can contain more than one field, such as a field for the batch of stock and a field for the material number for the stock.

| Field | Key | Description |
|---|---|---|
| MANDT | X | Client |
| (Stock | X | The business key can contain several fields (e.g. |
| business key) | | MATNR/CHARG) |
| OWNER | X | Stock owner |
| CAT | X | Stock category (e.g. unrestricted stock, quality |
| | | inspection stock) |
| GUID | | Guid of stock ID. Is used in hierarchy |
| | | table /LIME/TREE and stock quantity table |
| | | in /LIME/STOCK |
| LOGSYS | | Logical system. Is needed if LIME contains data |
| | | from different systems. |

Examples of standard stock index tables are illustrated below. For example, the stock index table STOCK_I001 refers to stock that has a global trade item number and is owned by Smith. This stock has been assigned guid S2. Similarly, the stock index table STOCK_I002 refers to stock that is owned by Smith has an owner's material number (i.e., 4711). This stock has been assigned guid S3. The stock index table STOCK_I003 refers to stock owned by Smith that has an owner's material number and a best-before-date. This stock has been assigned guid S4.

STOCK_I001

| | GTIN | OWNER | GUID |
|---|---|---|---|
| Global trade item number | 1234512345123 | SMITH | S2 |

STOCK_I002

| | MATNR | OWNER | GUID |
|---|---|---|---|
| Material per owner | 4711 | SMITH | S3 |

STOCK_I003

| | MATNR | BBD | OWNER | GUID |
|---|---|---|---|---|
| Material with | 4711 | 02-04-2004 | SMITH | S4 |
| BestBeforeDate | | | | |

The hierarchy relationships between locations, handling units and stock quantities are kept in a hierarchy table /LIME/TREE that directly links serial numbers to a stock quantity. The hierarchy table is created by the inventory management engine based on the fields selected for the index tables described above. The table contains the relationship between a hierarchy node and its parents as well as all ancestors (grand-parents and higher). A node at the highest hierarchy level has a default parent ROOT. The node guid is the exact identifier of a node in the hierarchy and can be used to retrieve the complete path from a node to its ancestors. An example of the possible table fields for a hierarchy table is illustrated below.

| Field | Key | Description |
|---|---|---|
| MANDT | X | Client |
| GUID | X | Index guid of current node |
| GUID_PARENT | X | Index guid of parent or ancestor |
| GUID_NODE | X | Guid identifying the node in the tree |
| LVL | | Relationship level between node and parent/ |
| | | ancestor (level 1 for direct parent, level 2 for |
| | | grand-parent etc.) |
| TYPE | | Type (location, HU, stock quantity) of current |
| | | index guid. Needed to access the corresponding |
| | | index table (see field IDX) |
| IDX | | Reference to index table of current guid |
| | | (e.g. TYPE H with IDX 001 refers to HU index |
| | | table /LIME/HU_I001) |
| TYPE_PARENT | | Type (location, HU, stock quantity) of |
| | | parent/ancestor |
| IDX_PARENT | | Reference to index table of parent/ancestor |

The relationship between the guids and the stock quantity is found in the stock quantity table /LIME/STOCK, which is the only table that contains stock quantities. A stock quantity is found only at a specific node in the LIME hierarchy. The unit of measure is a key field, so multiple transaction quantities (“MTQ”) at the same node have different entries in /LIME/STOCK. An example of the table fields in the stock quantity table is provided below.

| Field | Key | Description |
|---|---|---|
| MANDT | X | Client |
| GUID | X | Index guid of stock ID (never HU or location) |
| GUID_PARENT | X | Index guid of parent (HU or location) |
| VSI | X | Virtual stock indicator. Indicates whether the |
| | | stock quantity relates to a physical or a virtual |
| | | stock |
| UNIT | X | Unit of measure (key field because of MTQ |
| | | quantities) |
| QUAN | | Stock quantity (QUAN 19 with 6 decimals) |
| GUID_NODE | | Node guid in the LIME tree. Needed for quick |
| | | access from a /LIME/TREE entry |

Serial numbers can be stored in LIME in two ways: (1) as stock quantity nodes with a quantity of 1 for each serial number and (2) in a serial number table linked to a stock quantity node (e.g., 2 serial number entries linked to a stock quantity node with a quantity of 2). An example of the fields in the serial number table (/LIME/SERIAL) is illustrated below.

| Field | Key | Description |
|---|---|---|
| MANDT | X | Client |
| GUID_NODE | X | Node guid in the LIME tree. Needed for quick |
| | | access from a /LIME/TREE or a /LIME/STOCK |
| | | entry |
| VSI | X | Virtual stock indicator. Indicates whether the |
| | | stock quantity relates to a physical or a virtual |
| | | stock |
| SERIAL | X | Serial number (CHAR 40) |
| GUID | | Index guid of stock ID (never HU or location). |
| | | Needed for a quick access during queries and for |
| | | uniqueness check (via a unique index). |

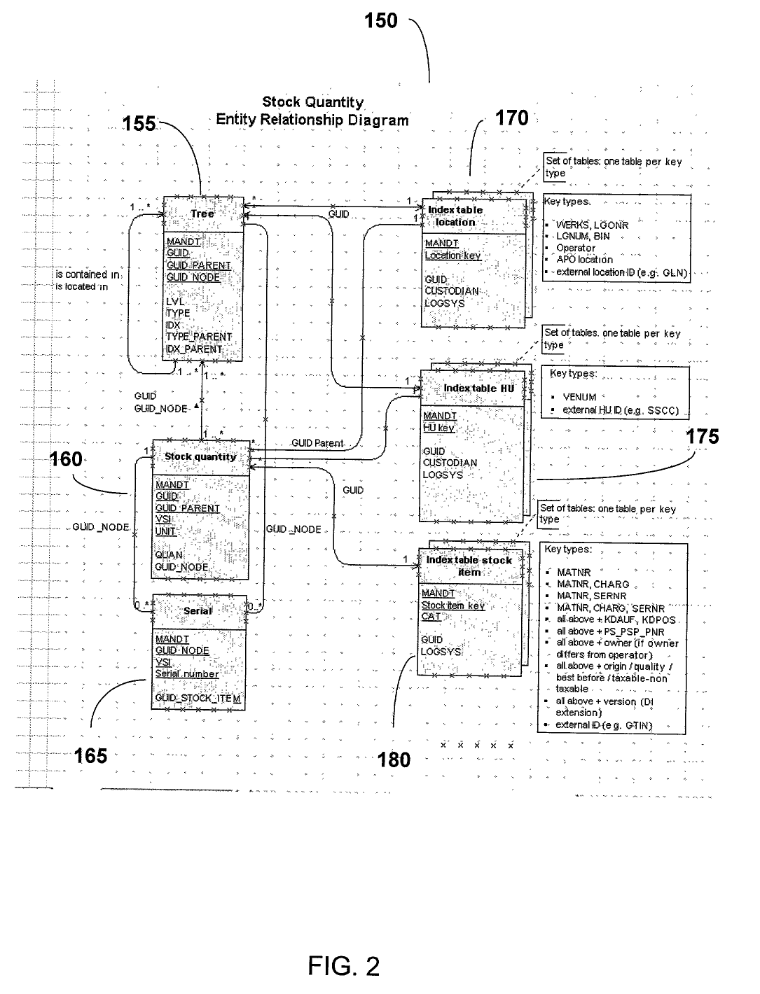

Referring to FIG. 2, by combining the above hierarchy tables, stock item tables, serial number tables, and index tables in a single database, an inventory management system, such as SAP's LIME inventory management system, can be operated faster and more accurately than an inventory management system in which these tables are separated into different databases. In one implementation of the combined inventory management system, a stock quantity entity relationship diagram 150 used in the inventory management system includes a hierarchy tree table 155, a stock quantity table 160, and a serial number table 165. The entity relationship diagram also includes a location index table 170, one or more handling unit index tables 175, and one or more stock item index tables 180. Of particular importance is the inclusion in the location index tables 170 and the handling unit index location tables 175 of custodian fields. Similarly, the stock item index table 180 has a key to the owner name if the owner is not the same as the operator. As such, there is a separation between the custodian of the stock and the owner of the stock. As known to one of ordinary skill in the art of database design, the diagram 150 illustrates the relationships within the database between the tables 155, 160, 165 and the index tables 170, 175, 180. These tables and their use in inventory management are described in greater detail below.

In particular, the manipulation of these tables during particular operations is explained. For example, a warehouse operator may provide storage space to more than one company. These companies own the stock in the warehouse and the operator merely provides logistics support. Nonetheless, the warehouse operator must be able to identify the owner of the stock within the warehouse in the event of, for example, a change in ownership in the stock. The warehouse operator also must have the ability to separate its function as a custodian of the inventory from the owner's function as the legal owner of the inventory. Because of circumstances such as, e.g., a change in stock ownership, the inventory management is operated to be independent of the legal structure of a company by treating as separate the custodian or stock operator (i.e., warehouse operator) and the stock owner. In this manner, changes in the company structure, such as merging and outsourcing, are easily handled within the inventory management system 150 illustrated in FIG. 2. Other examples of events that cause a change in stock ownership without a change in stock location include, the outsourcing of a warehouse, a change in a trading partner in a supply chain, the management of the book stock level for each owner for a commingled location, or other events. These events are contemplated by the inventory management system 150 and the owner can be easily changed within the inventory management system by merely changing one field of the stock index table.

A change in ownership also will be important in other applications, such as finance and accounting. For example, if a first company sells stock items to a second company, both companies will want to adjust their finance and accounting records to include the impact that the transfer will incur. Thus, the financial effects of the transfer should be readily ascertained from the inventory management system 150 by using, for example, interfaces to external applications that provide the necessary data to run those external applications.

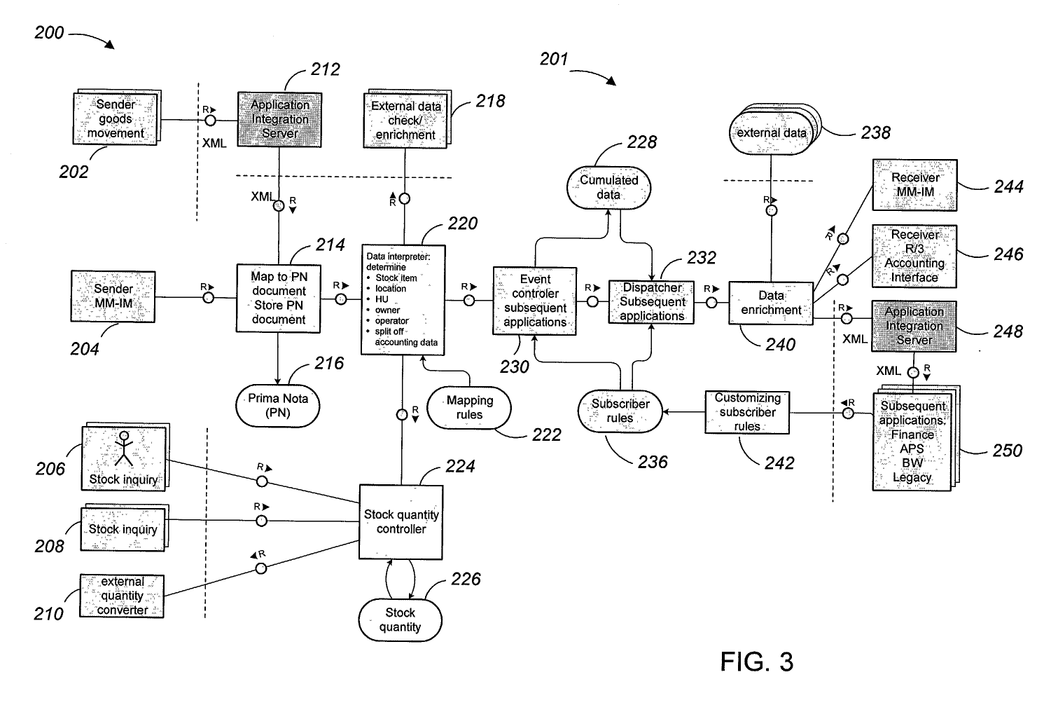

FIG. 3 illustrates a schematic block diagram of an inventory management system 200 that includes an inventory management engine 201, such as SAP's LIME inventory management engine, that has interfaces to outside applications. Again, although the description of the inventory management engine is directed to the details of one particular implementation of an inventory management engine, namely, that of SAP's LIME, the principles and the methods described are generally applicable to any inventory management engine. In FIG. 3, all the blocks outside the dashed lines (that is, blocks 202-212, 218, 238, and 244-250) represent external components, while all the blocks inside the dashed lines (that is, blocks 214-216, 220-236, and 240-242) represent the inventory management engine 201.

LIME receives a message from a calling application 202, 204 containing stock movement data or physical inventory data. The message can be an XML document that is forwarded to LIME via an Application Integration Server 212 or it can be a function module call from a mySAP application 204. The incoming document is kept by LIME during the whole process.

LIME then generates 214 an update log (prima nota) 216 if necessary. The prima nota holds all input data that is required for recovery in the event of a system failure or auditing. After generating the prima nota 216, LIME extracts 220 its own data from the incoming document, such as location, handling unit, stock quantities, and so on and maps the data to the LIME internal structures described above according to a set of mapping rules 222. An external data check/enrichment 218 is also carried out, if necessary, and a stock quantity controller 224 updates a stock quantity database 226.

External applications 206-210 can submit stock inquiries to LIME through the stock quantity controller 224. Each application that is interested in stock movement, stock ownership, or physical inventory documents subscribes to LIME, and defines the dispatching rules for the documents. Users of the LIME application can include rules based on various conditions, such as which criteria are relevant for the subscribing application (for example, finance applications need to be informed of changes in stock ownership), how often the subscribing application will receive documents from LIME (for example, once per day), and whether the documents will be cumulated by LIME before dispatching and what the aggregation rules are.

An event controller 230 then checks the subscriber rules 236 for the various applications and forwards the document (maybe in cumulated form) to the interested applications using a dispatcher 232. The forwarding may include adding cumulated data 228 and obtaining other external data 238 for enrichment 240 with the LIME data before the LIME data is passed on to the receiving applications. The receiving applications may include an MM-IM system 244, a R/3 accounting interface 246, and an application integration server 248. The application integration server 248 may call various subsequent applications 250, such as finance applications, legacy applications, and so on. These applications can in turn customize 242 the subscriber rules 236 used by the event controller to dynamically change the behavior of the event controller 230 and dispatcher 232 before the next event takes place.

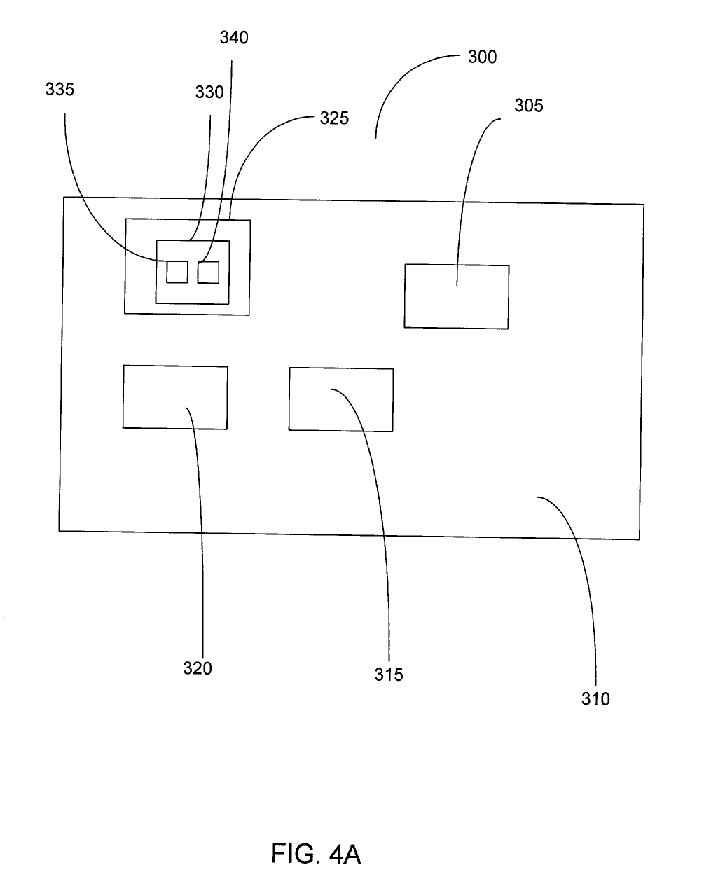

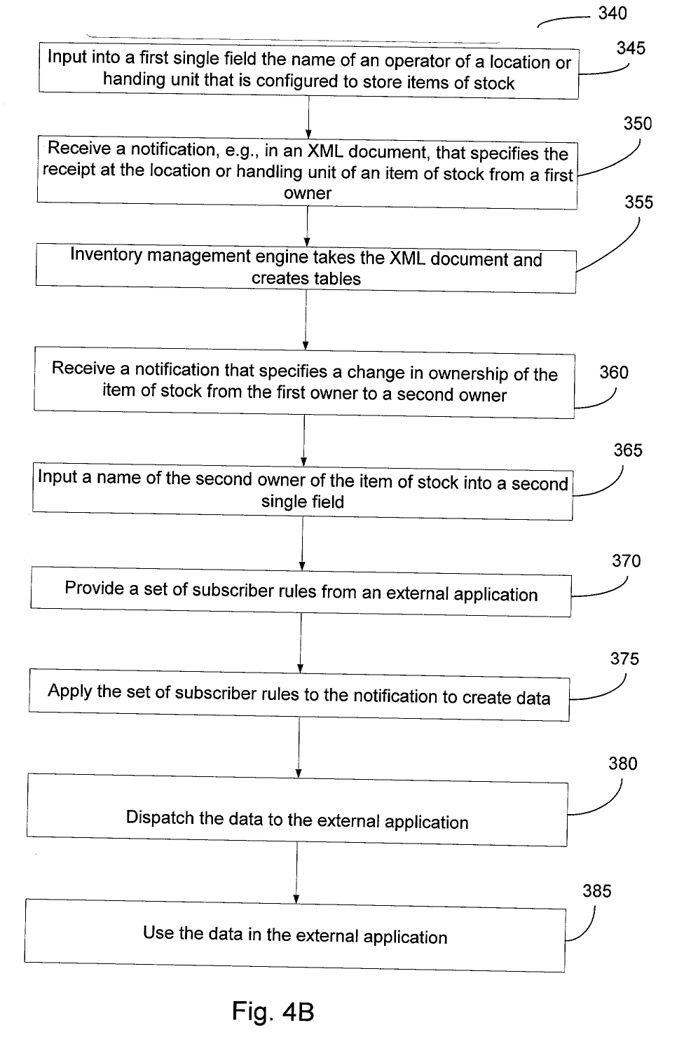

FIG. 4A is a diagram of the layout of a location 300 (e.g., a warehouse) in which the item of stock is placed and is described by the process of FIG. 4B. FIG. 4B is a flow chart illustrating, at a high level, a basic application of the inventory management system 200 and inventory management engine 201 to a situation in which an operator of, for example, the location 300 (i.e., the warehouse), is a custodian of stock items for other companies. A first owner places an item of stock in the operator's warehouse and at some later time transfers ownership of the item of stock to a second owner. The warehouse may be part of a supply chain and the operator of the warehouse accesses an inventory management system that is operated by the ultimate manufacturer of the items in the supply chain, as described above with respect to FIG. 1B.

In this example, the location 300 includes five storage locations 305, 310, 315, 320, and 325. Storage locations 305, 315, 320, and 325 may be, for example, refrigerated containers. Storage location 310 may be, for example, an area within the location 300 that is dedicated to a particular category of stock items or handling units. The storage location 325 may contain a handling unit 330 that is implemented in the form of a pallet. The warehouse operator stores two stock items 335 and 340 on that pallet. The two stock items may be, for example, part of a supply chain. In this example, the stock item 335 is initially owned by a first owner, transported for the owner to the location 300, and stored within the storage location 325 on the handling unit 330. At a subsequent time, a second owner takes ownership of the stock item 335 although the stock item's location does not immediately change. The warehouse operator notes this change in ownership and uses the inventory management engine to update an inventory management system and transfer data to external applications.

In a process 340 of FIG. 4B, the operator has storage locations and handling units within the warehouse. At some point in time, the operator must enter a location business key into an index table for the warehouse location 300; location business keys into index tables for the storage locations 305, 310, 315, 320, and 325; and a handling unit business key into an index table for the handling unit 330. Once these business keys are entered into the inventory management engine, guids will be generated that are linked to the business keys. The warehouse operator also must enter a business key into the location index that identifies the operator (step 345). The business key may, for example, link the location 300 to information about the operator.

As described above with respect to FIG. 4A, the first owner sends a stock item 335 in a supply chain to the warehouse. When the stock item 335 arrives, it may have accompanying paperwork that notifies the warehouse operator of the stock item and identifies the owner of the stock item, a material number or name associated with the stock item, a batch number associated with the stock item, etc. (step 350). Typically, as described above with respect to FIG. 3, the document is in the form of an XML document such that the data is entered directly into the inventory management engine. The inventory management engine then creates the tables described above using the information included in the XML document (step 355). The inventory management engine can also specify the location of the stock items within the warehouse.

A second owner of the stock item 335 in the supply chain later takes ownership of the stock item, although the stock item remains within the warehouse. For example, the first owner and the second owner may have an agreement that after the stock item has been in the warehouse for two days, ownership passes to the second owner. Thus, the operator of the warehouse will receive notification in some form (e.g., a facsimile, an XML document, an automated message, etc.) that the ownership of the stock item 335 has been changed from the first owner to the second owner (step 360). Because of the structure of the database and inventory management engine, the warehouse operator needs only to change one field in a stock item index table, namely, the owner name (step 365). All of the attributes associated with the stock item will remain the same and be linked through the guids to the second owner.

The first owner and the second owner may need to update their financial records and accounting records to reflect the transfer of ownership. This is accomplished using applications that are external to the inventory management system. To provide the needed data to the external applications, the external applications provide a set of subscriber rules to the inventory management system (step 370). The subscriber rules, for example, can request that daily batches of information, rather than a continuous stream of information, be provided to the external applications. The inventory management system applies the subscriber rules and creates the data for the external applications (step 375). Using the subscriber rules, the inventory management system dispatches the data to the external application (step 380). The external applications use the data to, for example, revise the financial valuations (step 385).

Based on the general characteristics of the tables, inventory management system, and inventory management engine described above, following are examples of the implementation and use of the system and engine with emphasis on the tables.

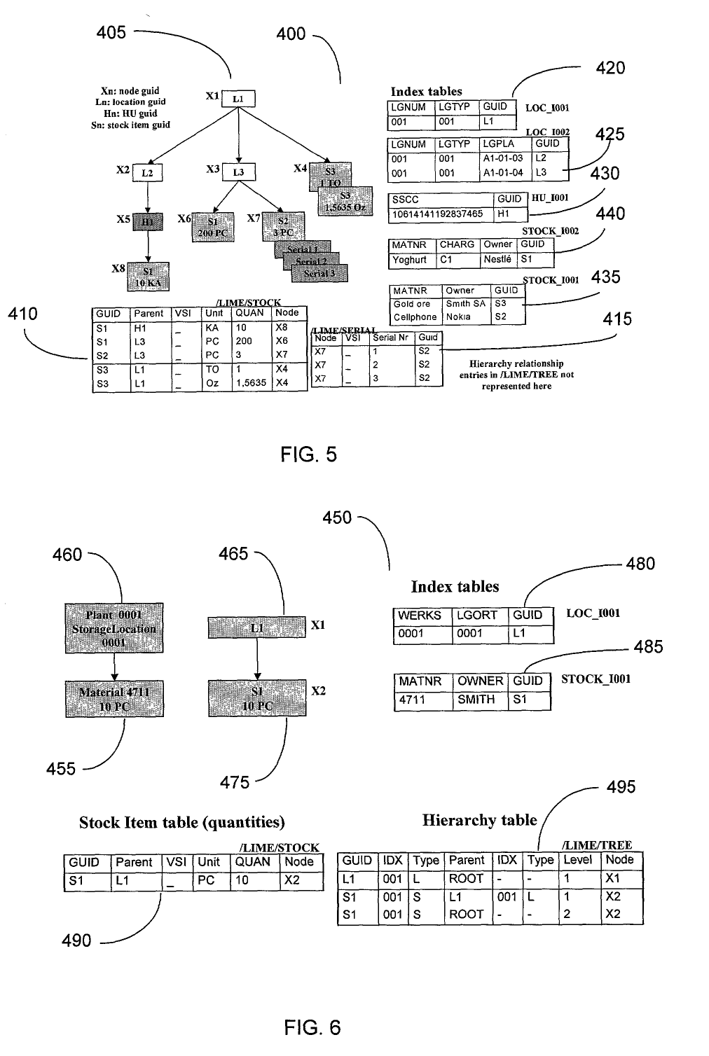

FIG. 5 is an illustration of the hierarchy and some of the relevant tables and index tables in an inventory management system 400 that includes 10 KA of yoghurt, 200 PC of yogurt, 3 PC of cell phones, and 1 TO of gold ore. A hierarchy tree 405 shows the relative hierarchy of the plant location, storage locations within the plant, handling units, and stock quantities. The stock quantity table 410, labeled /LIME/STOCK, contains the stock quantities for the yoghurt, the cell phones, and the gold ore and includes guids. The serial number table 415, labeled /LIME/SERIAL, contains the serial numbers for those stocks that have serial numbers, namely, the three cell phones, and the guids that link the serial number table 415 to the stock quantity table 410 and the index tables relevant to the cell phones.

The index tables link business keys to the guids. For example, a location index table 420, labeled LOC_I001, links a location guid L1 to a particular plant and the business key for that plant. In the hierarchy tree 405, the plant is represented by a node guid X1. A location index table 425, labeled LOC_I002, links a pair of location guids L2 and L3 to a particular pair of storage locations and the business key for those storage locations. In the hierarchy tree 405, the storage locations are represented by node guids X2 and X3. A handling unit index table 430, labeled HU_I001, links a location guid H1 to a particular handling unit and the business key for that handling unit. In this example, the business key for the handling unit includes a serial shipping container code that is unique to that shipping container. In the hierarchy tree 405, the handling unit is represented by a node guid X5. A pair of stock index tables 435 and 440, labeled LOC_I001 and LOC_I002, respectively, link a pair of stock guids S3, S2 and S1, respectively, to business keys for the stock. For example, the stock index table 435 links stock guid S2 to cell phones owned by Nokia and stock guid S3 to gold ore owned by Smith SA. The stock index table 440 links stock guid S1 to a batch C1 of yoghurt owned by Nestle. Although not represented in FIG. 5, a hierarchy table can be used that links the node guids to the stock guids.

The inventory management system 400 can be used to quickly and easily track, maintain, or change the ownership of items at any location in a supply chain that is described in the location index tables used by the inventory management system. For example, the location guid L1 can by linked to a warehouse operator. As such, there will be a distinct separation of the warehouse operator who is the custodian of the stock, linked in the location index table 420 (LOC_I001), and the actual legal owner of the stock, linked in the stock quantity table 410 (/LIME/STOCK). Thus, if the ownership of the gold ore owned by Smith SA is transferred to another party, for example, by merger, acquisition, sale, etc., the stock index table 435 is updated to replace Smith SA with the name of the new owner. This change in ownership does not require that other tables be changed because the ownership data is kept in only one table.

FIG. 6 is an illustration of the relevant tables created in an inventory management system 450 to describe the storage of 10 pieces of a material having a material number 4711 in a storage location within a plant. A block 455 represents the 10 pieces of the material 4711. A block 460 represents the physical location of the 10 pieces of the material 4711. The physical location is made up of a storage location and a plant. In this example, the storage location has been assigned the number 0001 and the plant has been assigned the number 0001. In a database used to implement the inventory management system 450, a hierarchy listing 470 includes a block 475 that represents the 10 pieces of the material 4711 and a block 465 that represents the physical location of the storage location 0001 and the plant 0001. In the hierarchy listing 475, the block 465 is assigned a GUID_Node X1 and the block 475 is assigned a GUID_Node X2. The block 475 is assigned a guid S1, which is a number that is globally unique to those 10 pieces of the material 4711. The block 465 is assigned a GUID L1, which is a number that is globally unique to that storage location and plant.

The inventory management system 450 also includes a location index table 480, a stock index table 485, a stock item table 490, and a hierarchy table 495. The location index table 480 provides the relationship between the GUID L1 and the plant and storage location. Although not shown, the location index table 480 can include a data field for the name or identifier of the custodian, i.e., a warehouse operator who controls, operates, and/or owns the plant and storage locations. Including a data field for the name or identifier of the custodian is useful in situations in which a warehouse operator does not own the stock in the warehouse but instead manages the stock for one or more companies.

The stock index table 485 provides the relationship between the material number (e.g., 4711), the owner of the material, and the GUID S1. The stock item table 490 provides the relationship between the GUID S1, the GUID L1, the unit of measure, the quantity of the material, and the GUID_Node in the hierarchy listing that describes the location at which the material 4711 is stored. The hierarchy table 495 contains the hierarchy information for the locations (i.e., plant 0001 and storage location 0001) and relates the GUIDs L1 and S1 to the hierarchy levels. For example, the hierarchy table 495 shows that the GUID L1 is at the first level from the root. The table 495 also shows that the GUID S1 is at the second level from the root or the first level from the plant/storage location. The GUID_Nodes are listed in the hierarchy table 495 and are used to provide quick access to the stock item table 490.

The inventory management system 450 can be used by a warehouse operator to easily manage, for example, a transaction that involves a change in ownership of the material 4711. As illustrated in FIG. 6, the stock index table 485 shows the owner of the material 4711 to be a company or an individual named SMITH. Assuming that the warehouse operator merely provides storage facilities and logistics support for companies, the warehouse operator needs to know the owner of all the material stored in its warehouse. If there is a change in ownership of some or all of the material in the warehouse, the warehouse operator is advantageously served if it is easy to change the ownership in the inventory management system. In the inventory management system 450, the warehouse operator merely accesses the stock index table 485 and changes the owner name in the owner name field from Smith to the name of the new owner. If the material number is also changed, the warehouse operator also changes the material number in the material number field from 4711 to the new material number. Although it is not always necessary to include the stock owner field in stock index tables, in general, including the stock owner field will improve supply chain visibility in collaborative scenarios in which the partners in the collaboration have access to the inventory management system. After the owner names are changed, the inventory management system applies a set of subscriber rules to create data and dispatch that data to external applications, such as financial and accounting applications.

A number of embodiments of the invention have been described. Nevertheless, it will be understood that various modifications may be made without departing from the spirit and scope of the invention. Accordingly, other embodiments are within the scope of the following claims.

What is claimed is:

1. A method of updating information relating to an item of stock in a supply chain that resides in a storage facility of a custodian of the stock when the ownership of the item of stock passes from a first owner to a second owner, the method comprising:
providing a first data structure representing the custodian of the item of stock;
providing a second separate data structure representing the owner of the item of stock; and
passing the ownership of the item of stock from the first owner to the second owner, wherein passing the ownership comprises changing the name from the first owner to the second owner in a field in the second data structure.

2. The method of claim 1, further comprising inputting the name of the custodian of the item of stock in a single field in the first data structure.

3. The method of claim 1, further comprising inputting the name of the first owner of the item of stock in a single field in the second data structure.

4. The method of claim 3, wherein inputting the name of the first owner of the item of stock comprises retrieving the name of the first owner from an XML document.

5. The method of claim 1, wherein passing the ownership comprises receiving a notification that specifies a change in ownership of the item of stock from the first owner to the second owner.

6. The method of claim 5, wherein receiving a notification that specifies a change in ownership comprises receiving an XML document.

7. The method of claim 1, further comprising providing a set of subscriber rules from an external application.

8. The method of claim 7, further comprising applying the set of subscriber rules to a notification of a change in ownership of the stock item to create data.

9. The method of claim 8, further comprising dispatching the data to the external application.

10. The method of claim 7, wherein providing a set of subscriber rules comprises providing a set of subscriber rules of an accounting application.

11. The method of claim 7, wherein providing a set of subscriber rules comprises providing a set of subscriber rules of a finance application.

12. The method of claim 7, wherein providing a set of subscriber rules comprises providing criteria that is relevant to the external application.

13. An article comprising a computer-readable medium that stores executable instructions for causing a computer system to:
provide a first data structure representing the custodian of the item of stock;
provide a second separate data structure representing the owner of the item of stock; and
pass the ownership of the item of stock from the first owner to the second owner, wherein passing the ownership comprises changing the name of the owner from the first owner to the second owner in a field in the second data structure.

14. The article of claim 13, further comprising instructions for inputting the name of the custodian of the item of stock, wherein inputting the name of the custodian comprises inputting the name of the custodian into a single field in the first data structure.

15. The article of claim 13, further comprising instructions for inputting the name of the first owner of the item of stock, wherein inputting the name of the first owner comprises inputting the name of the first owner into a single field in the second data structure.

16. The article of claim 15, further comprising instructions for inputting the name by retrieving the name of the first owner from an XML document.

17. The article of claim 13, further comprising instructions for passing the ownership, wherein the instructions comprise a notification that specifies a change in ownership of the item of stock from the first owner to the second owner.

18. The article of claim 17, wherein the notification comprises an XML document.

19. The article of claim 13, further comprising instructions for providing a set of subscriber rules from an external application.

20. The article of claim 19, further comprising instructions for applying the set of subscriber rules to a notification of a change in ownership to create data.

21. The article of claim 20, further comprising instructions for dispatching the data to the external application.

22. The article of claim 19, further comprising instructions for providing a set of subscriber rules of an accounting application.

23. The article of claim 19, further comprising instructions for providing a set of subscriber rules of a finance application.

24. The article of claim 19, further comprising instructions for providing criteria that is relevant to the external application.

25. A system comprising:
one or more external computer systems; and
an inventory management computer coupled to the external computer systems over a network, the inventory management computer being operable to:
provide a first data structure representing a custodian of an item of stock;
provide a second separate data structure representing an owner of the item of stock; and
pass the ownership of the item of stock from the first owner to a second owner, wherein passing the ownership comprises changing the name of the owner from the first owner to a second owner in a field in the second data structure.

26. The system of claim 25, wherein the inventory management computer is further operable to input the name of the custodian of the item of stock into a single field in the first data structure.

27. The system of claim 25, wherein the inventory management computer is further operable to input the name of the first owner of the item of stock into a single field in the second data structure.

28. The system of claim 27, wherein the inventory management computer is further operable to input the name of the first owner of the item of stock by retrieving the name of the first owner from an XML document.

29. The system of claim 25, wherein the inventory management computer is further operable to pass the ownership by receiving a notification that specifies a change in ownership of the item of stock from the first owner to the second owner.

30. The system of claim 29, wherein the notification comprises an XML document.

31. The system of claim 25, wherein the inventory management computer is further operable to provide a set of subscriber rules from an external application.

32. The system of claim 29, wherein the inventory management computer is further operable to apply the set of subscriber rules to a notification of a change in ownership to create data.

33. The system of claim 32, wherein the inventory management computer is further operable to dispatch the data to an external application.

34. The system of claim 31, wherein the set of subscriber rules further comprises a set of subscriber rules of an accounting application.

35. The system of claim 31, wherein the set of subscriber rules further comprises a set of subscriber rules of a finance application.

36. The system of claim 31, wherein the set of subscriber rules further comprises criteria that is relevant to the external application.
